(19) United States
(12) Patent Application Publication
(10) Pub. No.: US 2013/0005340 A1
(43) Pub. Date: Jan. 3, 2013

(54) Handover Between Different Closed Subscriber Groups

(75) Inventors: Karol Drazynski, Wroclaw (PL); Johanna Katariina Pekonen, Espoo (FI); Seppo Ilmari Vesterinen, Oulunsalo (FI); Hanns Juergen Schwarzbauer, Grobenzell (DE)

(73) Assignee: Nokia Siemens Networks Oy

(21) Appl. No.: 13/537,332

(22) Filed: Jun. 29, 2012

Related U.S. Application Data
(60) Provisional application No. 61/503,005, filed on Jun. 30, 2011.

(51) Int. Cl. H04W 36/00

(52) U.S. Cl. 455/436

(57) ABSTRACT

A core network (MME or RNC for example) receives in an uplink message a first list of closed subscriber group (CSG) identities for cells which are neighbors to a network access node. The core network creates a third list by checking the first list received in the uplink message against a second list which is a user equipment's list of allowed CSG identities; and then sends the third list downlink to at least the network access node which provided the first list. In different embodiments the neighbors of the first list include only cells which are direct neighbor CSG cells; or alternatively is also has cells which are adjacent to the direct neighbor CSG cells.

### CROSS REFERENCE TO A RELATED APPLICATION

This patent application claims priority under 35 USC 119(e) from provisional U.S. Patent Application No. 61/503,005, filed on Jun. 30, 2011. That provisional application is hereby incorporated by reference in its entirety.

### TECHNICAL FIELD

The exemplary and non-limiting embodiments of this invention relate generally to wireless communication systems, methods, devices and computer programs and, more specifically, relate to the mechanisms for a user equipment handover between access nodes of different closed subscriber groups (different CSG-IDs).

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

ANR automatic neighbor relations

CGI cell global identity

CN core network

CSG closed subscriber group

eNB evolved NodeB, EUTRAN network access node/base station

EUTRAN evolved UTRAN (LTE)

GW gateway

HeNB home eNB

HO handover

ID identity

LTE long term evolution (EUTRAN)

MME mobility management entity

PCI physical cell identifier

RRC radio resource control

S-GW serving gateway

UE user equipment

UTRAN universal terrestrial radio access network

Both the UTRAN and the EUTRAN/LTE system include deployments of what are generically termed femto nodes. In UTRAN these are termed HNBs and in LTE these are termed HeNBs. Apart from possibly allowing emergency calls, typically these femto nodes offer wireless voice and data service to only certain authorized UEs which are the members or subscribers, referred to as the node's/cell's CSG. More generally the femto nodes privilege their subscribers and authorized guests for some wireless service as compared to non-subscribers. Some femto cells are arranged as a contiguous group such as across a university or corporate campus that serves a single subscriber list, and so femto networks are referred to as CSG networks whether or not they operate solo or as part of such a group. UE's also have stored in their local memory a CSG list which identifies all those CSG cells to which the UE is authorized access.

While femto nodes are often characterized as restricting access to non-subscribers, in fact they can operate in other modes besides that closed access mode. In the hybrid access mode the HNB/HeNB operates as a CSG cell where at the same time non-CSG members are allowed access, and in the open access mode the HNB/HeNB operates as a normal cell (i.e. a non-CSG cell).

Current mobility scenarios, for example in LTE involving CSG-capable UEs and HeNBs, are based on the assumption that the core network will perform final access control aimed at verifying whether the UE is a member of the CSG supported by the target cell. This is because the CN can easily obtain the UE's list of allowed CSGs, either from another node within that same CN in the case the UE is within its home network or from the UE's home network for the case the UE is roaming in a visiting network. In the UTRAN system this final access control verification can be done at the HNB gateway rather than in the CN itself. It is efficient to provide for UE handovers between CSG cells with the lowest possible signalling load while still maintaining proper functionality of inbound and outbound CSG mobility.

In the LTE system specifically, there is an X2 interface directly between adjacent CSG cells, even if they are members of different CSGs (and thus have different CSG-IDs). Currently there are no mechanisms describing how an inter-CSG HO between femtocells over that X2 interface should be performed. One challenge in this HO scenario is how and where to perform the access control since the handover should happen over the X2 interface and the source or serving HeNB and target HeNB are configured with a different CSG-ID. During such a HO the network should verify whether the terminal indeed has access rights for the target femtocell. While the UE and the CN both have the UE's Allowed CSG list, in current development of LTE neither the serving nor the target HeNB have information about whether a UE is allowed to access a particular neighboring CSG/hybrid cell.

The above HO scenario is shown at FIG. 1. One possible manner to handle this HO scenario is have the source HeNB issue to the MME an inquiry for each of the source HeNB's connected subscribers which are trying to handover to a neighboring CSG/Hybrid cell. In this case for each subscriber reporting a potential HeNB HO candidate, the MME would need to provide related CSG subscription information as is generally shown at FIG. 1 and further detailed at FIG. 2. FIG. 2 illustrates that this is a rather high signaling load, especially when one considers that a) the number of deployed femtocells is expected to rise significantly in order to offer substantial macrocell offload; b) such femtocells will likely be deployed using different CSG-IDs still with an X2 logical interface between them for limiting the CN involvement in mobility and load balancing procedures; and c) the coverage area of these femtocells will be small meaning HOs between them may happen very often. The FIG. 2 signaling is seen to require in practice too many inquiries to the MME.

While inter-CSG mobility enhancement are currently being considered formally for 3GPP Release-11, the inventors are aware of no relevant prior art on this topic. For macro eNBs (publically accessible network cells) there was once a proposal in 3GPP Release 9 (see 3GPP TR 23.830, ver. 9.0.0 for section 6.3.6.2.1) which had the MME delivering the UE's Allowed CSG ID list to the source (or serving) RAN as part of Initial Context Setup request and Handover Request messages as set forth below:
As currently defined, the Handover Restriction List IE is included in various S1-AP and X2-AP messages such as INITIAL CONTEXT SETUP REQUEST and HANDOVER REQUEST, and it is used by the source eNB to determine a target cell based on equivalent PLMNs and forbidden TA/LAs for the UE.
To support in-bound connected mode handover, it is proposed to expand the Handover Restriction List IE to also include the Allowed CSG list of the UE. This allows the source eNB to use this information to determine if a target CSG cell is suitable for handover.

This procedure, which was to be incorporated into 3GPP Release 9, assumes that the MME delivers the UE's full list of the CSG IDs. But to extend this to femto cells providing restricted access is a potential security risk because if the source RAN is a HeNB in a residential environment which receives the UE's full Allowed CSG ID list, such a list would also include CSG IDs which are not at all relevant for the mobility decisions in the source RAN.

The exemplary embodiments of the invention detailed below address procedures for enabling a HO of a UE between femtocells bearing different CSG-IDs which avoid the high signaling load and security concern noted above.

### SUMMARY

According to a first aspect of the invention there is a method comprising receiving in an uplink message a first list of closed subscriber group identities for cells which are neighbors to a network access node; creating a third list by checking the first list received in the uplink message against a second list which is a user equipment's list of allowed closed subscriber group identities; and sending the third list downlink to at least the network access node which provided the first list.

According to a second aspect of the invention there is an apparatus comprising at least one processor; and at least one memory storing computer program code. In this aspect the at least one memory with the computer program code is configured with the at least one processor to cause the apparatus to perform actions comprising: receiving in an uplink message a first list of closed subscriber group identities for cells which are neighbors to a network access node; creating a third list by checking the first list received in the uplink message against a second list which is a user equipment's list of allowed closed subscriber group identities; and sending the third list downlink to at least the network access node which provided the first list.

According to a third aspect of the invention there is a memory storing computer program code, which when executed by at least one processor result in actions comprising: receiving in an uplink message a first list of closed subscriber group identities for cells which are neighbors to a network access node; creating a third list by checking the first list received in the uplink message against a second list which is a user equipment's list of allowed closed subscriber group identities; and sending the third list downlink to at least the network access node which provided the first list.

### BRIEF DESCRIPTION OF THE DRAWINGS

FIG. 1 is a schematic drawing showing a serving/source HeNB requesting from an MME CSG subscription information for each connected UE moving towards an inter-CSG neighboring cell.

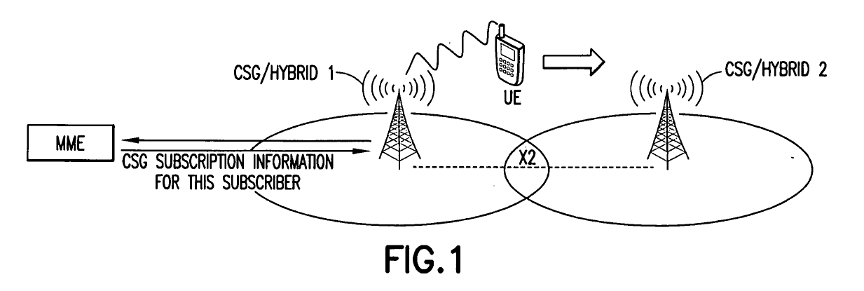

FIG. 2 is a signaling diagram showing the process of the MME inquiry of FIG. 1 for every subscriber for which the inter-CSG target HeNB may be a potential HO candidate.

FIG. 3 is a schematic drawing showing neighbor HeNBs and their respective CSG-IDs which the subject (source/serving) HeNB bearing CSG-ID #1 compiles for the neighbor CSG list it reports uplink to the MME according to an exemplary embodiment of the invention.

FIG. 4 is a process flow diagram showing how the neighbor CSG list compiled with respect to FIG. 3 is handled in the network and revised and reported back to the subject HeNB for use in access control for a particular UE according to an exemplary embodiment of the invention.

FIG. 5 is a signaling flow diagram showing the extended MME functionality to derive from the neighbor CSG list those CSG identities which match the subscriber's CSG subscription information and how such a list is used for access control by a HeNB according to an exemplary embodiment of the invention.

FIG. 6 is a signaling flow diagram showing a Path Switch procedure extended with the delivery of available CSG-ID list of the target HeNB (the new source/serving HeNB after an x2-based HO) neighboring cells from which the MME derives the CSG-IDs matching the subscriber's subscription information according to an exemplary embodiment of the invention.

FIG. 7 is a signaling flow showing an exemplary embodiment of the invention similar to that of FIG. 6 but using an S1-based handover procedure in the LTE system which is extended according to an exemplary embodiment of these teachings.

FIG. 8 is a logic flow diagram that illustrates the operation of a method, and a result of execution of computer program instructions embodied on a computer readable memory, in accordance with the exemplary embodiments of this invention.

FIG. 9 is a simplified block diagram of various electronic devices that are suitable for use in practicing the exemplary embodiments of this invention.

### DETAILED DESCRIPTION

The exemplary embodiments of the invention detailed below are in the context of the LTE radio access system but this is not limiting to the broader teachings of the invention disclosed herein. Such teachings are relevant to HOs between any pair of cells providing restricted access which do not share an identical subscriber list (e.g., cells with a different CSG-ID), and by example the UTRAN system also employs restricted access cells termed home node Bs or HNBs which may or may not have a direct logical interface between them similar to the X2 interface of the LTE system.

In general, the exemplary embodiments of the invention detailed herein limit the delivered information to only relevant CSG IDs. The relevant CSG IDs are those which are used in the neighboring cells of the serving cell and to which the serving cell has a direct interface (an X2 logical connection in LTE) to the possible HO candidates. The source and target restricted access cells/HeNBs/femtocells may be operating in hybrid and/or closed access mode. In particular the described inter-CSG HO includes additionally a method to communicate with the MME to derive relevant CSG subscription information concerning the involved subscriber.

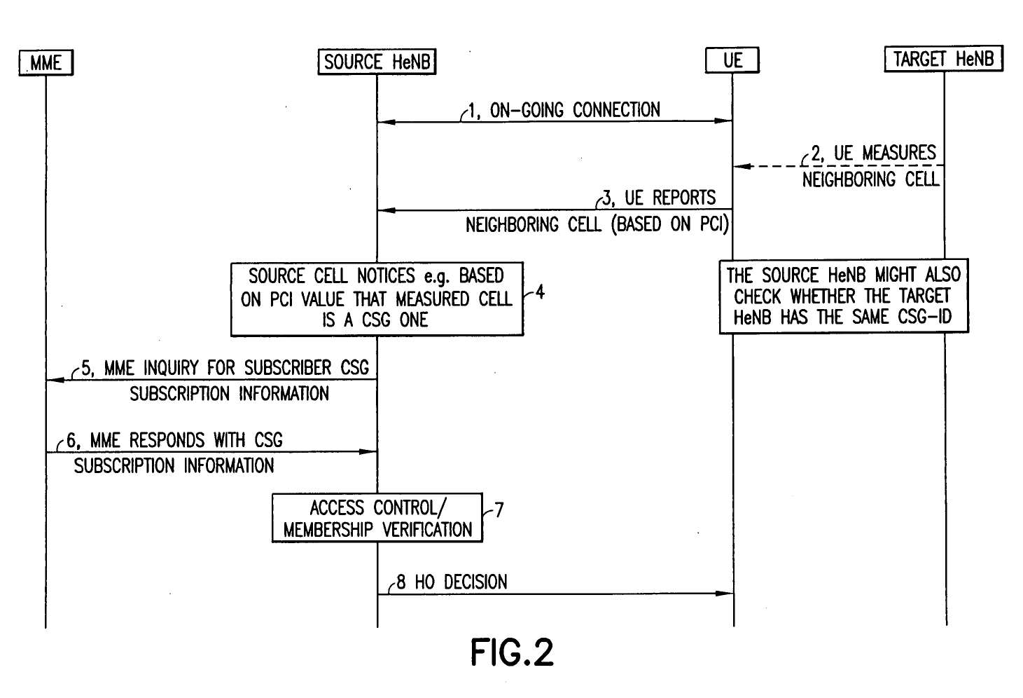

At FIG. 2 described above, the query from the source HeNB to the MME (step 5) occurs after the source HeNB has received a measurement report concerning a potential HeNB target cell (step 3). In the embodiments described by example below this inquiry to the MME is a bit different than that shown for FIG. 2, and the difference reduces the signaling load and addresses the security concern noted in the background section above. Below is a summary of how one particular embodiment of the invention is to operate in the LTE system.

Firstly, as an initial matter the HeNBs are to establish neighboring relationships with one another, such as for example using the ANR procedure of LTE for macro cells. But in this case in addition to the conventional ANR information such as PCI and CGI of their neighbors, the HeNB will also store the CSG-ID of their neighboring cells. In an embodiment each HeNB stores not only this information for its direct neighbors (those adjacent to the serving HeNB to whom a direct HO is possible) but also additional indirect neighbor cells (e.g., neighbor cells to whom a HO is possible through a single direct neighbor but not directly from the serving HeNB, those which are ‘once-removed’ from the serving HeNB, or adjacent to its direct neighbors).

Secondly, each terminal/UE initially establishing an RRC connection is to send its identity to the MME via the Initial UE Message. Unlike the conventional Initial UE Message, this one shall be extended by the serving HeNB to include a list of CSG-IDs of cells which the serving HeNB knows as its neighboring cells as determined e.g. from the ANR process above (direct and possibly also once-removed neighbors). This list only contains those CSD-IDs that are different from the CSG-ID that is used by the source HeNB itself.

Thirdly, in receiving this Initial UE Message together with the list of CSG-IDs broadcasted by the neighboring cells that this particular subscriber potentially can access from its current serving cell, the MME then takes three actions:
a. Look-up the CSG subscription information for this particular subscriber/UE that is indicated in the Initial UE Message IE.
b. Match the CSG subscription information with the provided list of theoretically accessible neighboring nodes with different CSG-IDs.
c. Derive from the CSG subscription information exactly those which match the CSG-IDs provided by the serving HeNB with those that this subscriber can actually access according to its CSG subscription.

Then (fourthly) the MME responds to the source (serving) HeNB with the UE context including the derived subset of CSG-IDs for which this particular subscriber/UE has access rights according to his subscription and available CSG-ID cells.

Fifth, the source HeNB then uses this information received from the MME to perform access control for this particular subscriber/UE for any of the possible target CSG/Hybrid HeNBs cells as seen from the perspective of the serving cell.

Sixth, once handed-over to the target cell as a result of the above described steps and UE movement out of the coverage area of the source cell, the target HeNB performs a path switch procedure to notify the MME that the target cell is now the new serving cell for that particular subscriber/UE. Specific to an LTE implementation this may be done via the conventional S1AP Path Switch Request message, but extended by these teachings to include a list of CSG-IDs which can be reached from the serving HeNB similar as was noted above (in the second step) for the original serving/source femtocell.

Seventh, in response to receiving this message from the new serving cell, the MME (which may or may not be the same MME as was handling the original serving cell) operates similarly as noted above in the third step; namely the MME looks up the CSG subscription information for that particular subscriber/UE and matches it against the list of CSG-IDs which are possible for HO as provided by the new serving HeNB. The MME then derives those CSG-IDs that match both lists and provides them to the serving HeNB via the S1AP: Path Switch Acknowledge message or other similar message. By doing so the new serving cell will now be aware which of its neighboring HeNBs are accessible for this particular subscriber/UE, and thus can perform access control accordingly in a manner similar to the fifth step above for the original serving cell.

This procedure can be repeated following the sixth and seventh steps above in the next HO attempts for possible new target HeNBs if the terminal/UE stays in the RRC CONNECTED mode. If instead the terminal/UE goes into RRC IDLE or some other mode lacking an active radio connection and re-establishes again an RRC connection in a HeNB cell the procedure can be repeated from the second step above.

By the above procedure the serving and target HeNBs will not need to perform additional MME enquiries for a subscriber's CSG subscription information which thereby mitigates the high signaling overhead issue noted in the background section above. Instead the only inquiry from the serving HeNB to the MME has a new information element IE which lists only the potential CSG-IDs which could be reached from a particular HeNB (directly or once-removed). Security is enhanced by substituting the UE's full allowed CSG list noted in the background section above by extending the functionality of the MME to derive a subset of CSG-IDs from the list provided by the serving cell matching the subscriber allowed CSG identities as described in the third step above. Note also that rather than the MME providing a list of allowed CSG-IDs (a CSG whitelist), it can equivalently provide a listing of disallowed CSG-IDs (a blacklist) which are those CSG-IDs in the serving HeNB's neighbor list which are not also on the UE's allowed CSG list. In either case the serving HeNB has the exact same information for handling mobility for the UE, since all the involved HeNBs understand in advance whether they are using the whitelist or the blacklist embodiment of these teachings.

It may be that there are occasional changes to the UE's CSG subscription information; for example a certain CSG-ID in the UE's allowed CSG list is now no longer allowed (or a new one is added). In this case the subscribers CSG subscription for a certain CSG as contained in the list expires or a new one is added which is a neighbor to the serving HeNB, the MME will inform the serving RAN (HeNB gateway or if the HeNB is interfaced directly to the MME then the HeNB itself) about the change with UE Context Update Request message and include the updated subset of CSG-IDs for which this particular subscriber has access rights according to its subscription and previously reported neighboring CSG cells.

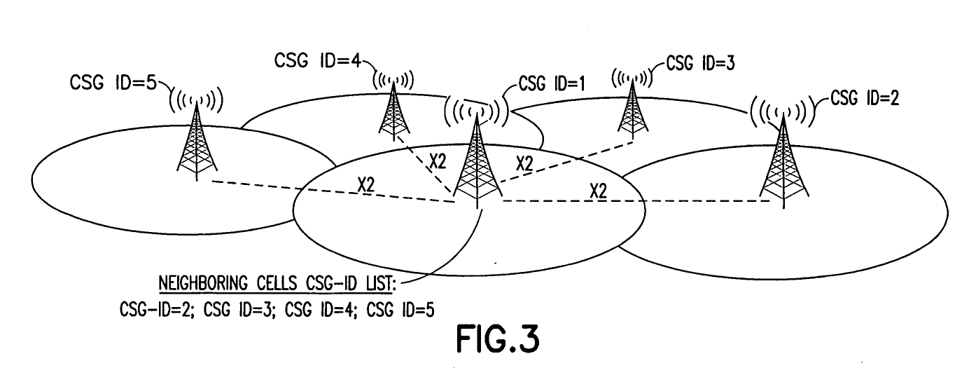

The above general steps are shown more particularly by examples illustrated at FIGS. 3-7 and detailed below.

Respecting the HeNBs establishing their respective neighbor relations as noted above at the first point, FIG. 3 shows this done in such a way that each of the HeNBs knows not only its direct neighbours but also (in an optional implementation) its once-removed HeNBs (non-adjacent to the subject HeNB but adjacent to its adjacent neighbors). FIG. 3 gives example CSG-IDs numbered 1 through 5. If we consider CSG-ID #1 as the subject (serving/source) HeNB, then its adjacent neighbors are those femtocells with CSG-ID #s 2 through 5 and the once-removed neighbour cells are those additional ones which are adjacent to any of those with CSG-ID #s 2 through 5. In an embodiment the subject HeNB (CSG-ID #1) gathers in its list the CSG-ID as well as the PCI and/or the CGI for those neighbour cells. In practice there may be other non-CSG neighbors, but only the relevant CSG neighbors are shown at FIG. 3. Also, in practice there may be several cells in the list represented by the same CSG-ID; those will be distinguished by their PCI and/or CGI, whichever is present in the list which the subject HeNB compiles. The HeNBs may in an embodiment use the LTE ANR procedures to compile this information for neighbour CSG cells.

The general procedure described in the eight steps outlined above may be considered as being divided into two different parts:
enabling access control during the first inter-CSG HO from the original serving/source HeNB (second through fifth steps above);
enabling access control during the second (the new serving/source HeNB) and all potentially following inter-CSG HOs (sixth through eighth steps above).

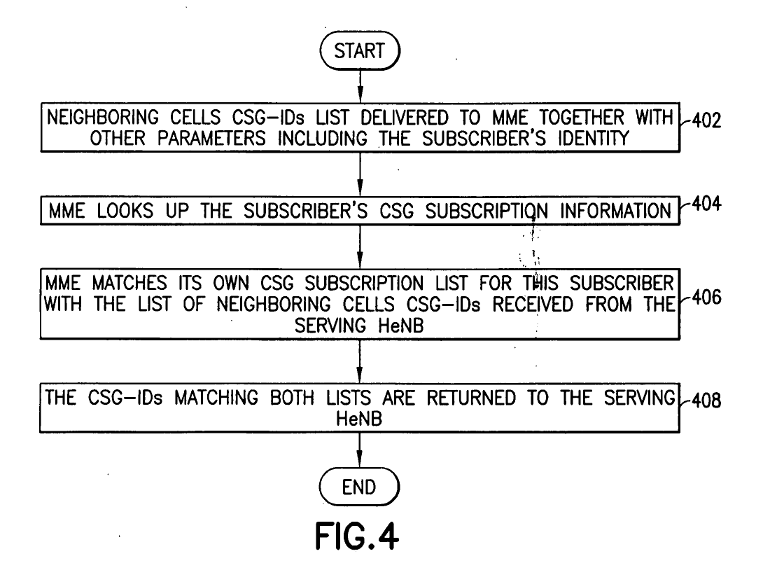

A terminal/UE establishing through a permitted closed/hybrid HeNB its RRC connection, due to initial attachment to the network or movement from RRC IDLE to RRC CONNECTED states, causes the serving/source cell/HeNB to send an Initial UE Message to the serving/source MME, such message being extended to include a list of neighboring cells' CSG-IDs. This is shown at block 402 of FIG. 4, and the list also includes the subscriber's identity (e.g., the UE's international mobile subscriber identity IMSI or its radio network temporary identifier RNTI).

At block 404 the MME upon reception of this message shall perform a match between the provided neighboring cells CSG-ID list and the list of allowed CSG-IDs for the particular subscriber identified in the message of block 402. The MME shall derive from the neighboring cells CSG-ID list only those identities that match the CSG subscription for that particular subscriber as shown at block 406. Alternatively the MME can instead compile a blacklist of those CSG-IDs within the list provided by the HeNB at block 402 which are not also listed in the UE's complete Allowed CSG list. In an exemplary embodiment the MME stores this information in the user context for the identified UE, which can be kept as long as the user stays in the RRC CONNECTED state. The MME can retain this information in the UE context when the terminal/UE moves to the RRC IDLE state for quick retrieval in case the UE soon moves back to a connected mode.

Then, once the MME compiles its whitelist or blacklist as the case may be for different implementations, those CSG-IDs are then sent to the serving/source HeNB as in block 408 of FIG. 4. The derived identities in the list provided at block 408 are those permitted for this subscriber/UE, and the MME may send it using the Initial Context setup request message. Based on this information the serving/source HeNB will be able to perform access control for the terminal/UE regarding various neighboring CSG-ID HeNBs.

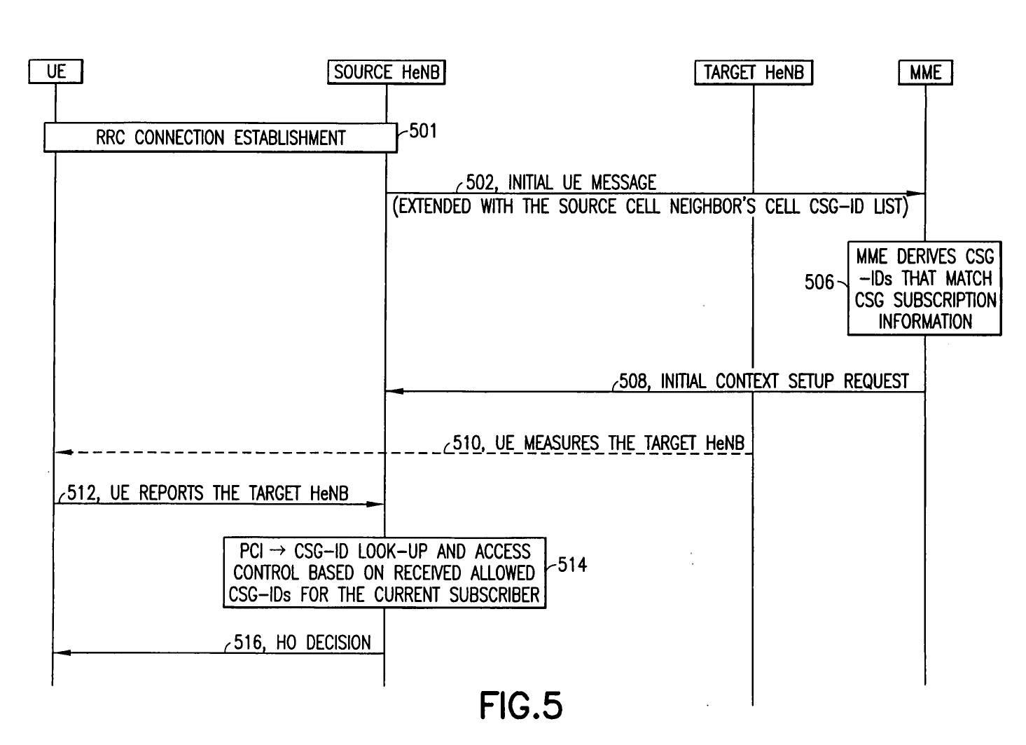

The process of FIG. 4 is expanded at the signalling flow diagram of FIG. 5, in which blocks 402, 406 and 408 of FIG. 4 correspond to reference numbers 502, 504 and 508 respectively of FIG. 5. At FIG. 5 there is shown the initial attachment of the UE to the HeNB at message exchange 501, RRC connection establishment signaling. Once the HeNB has received from the MME the UE's Initial Context Setup Request message which contains the neighbour-specific list of CSG-IDs to which this UE is allowed access (or disallowed access if implemented as a CSG blacklist), then at block 510 the UE measures the target HeNB and reports same to the currently serving/source HeNB at message 512 using the PCI of the target cell (since the UE does not know the CSG-ID of the target HeNB unless its decoded that cell's system information). If the measurement report of message 512 indicates that target cell has a reasonable signal strength at the UE for handover, then the serving/source HeNB then at block 514 looks up the CSG-ID of the target cell using the PCI given in the measurement report of message 512, checks that CSG-ID against the list the HeNB received in the context setup message at message 508, and if the UE is allowed access to the target cell makes a HO decision concerning that UE and that target HeNB at block 518

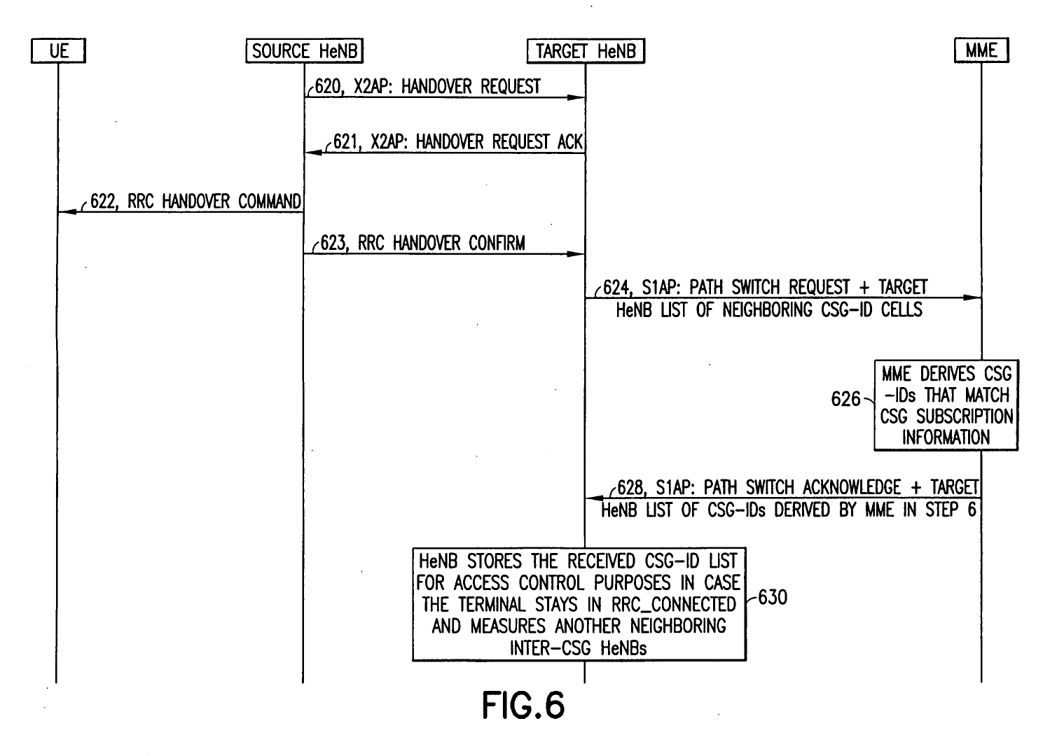

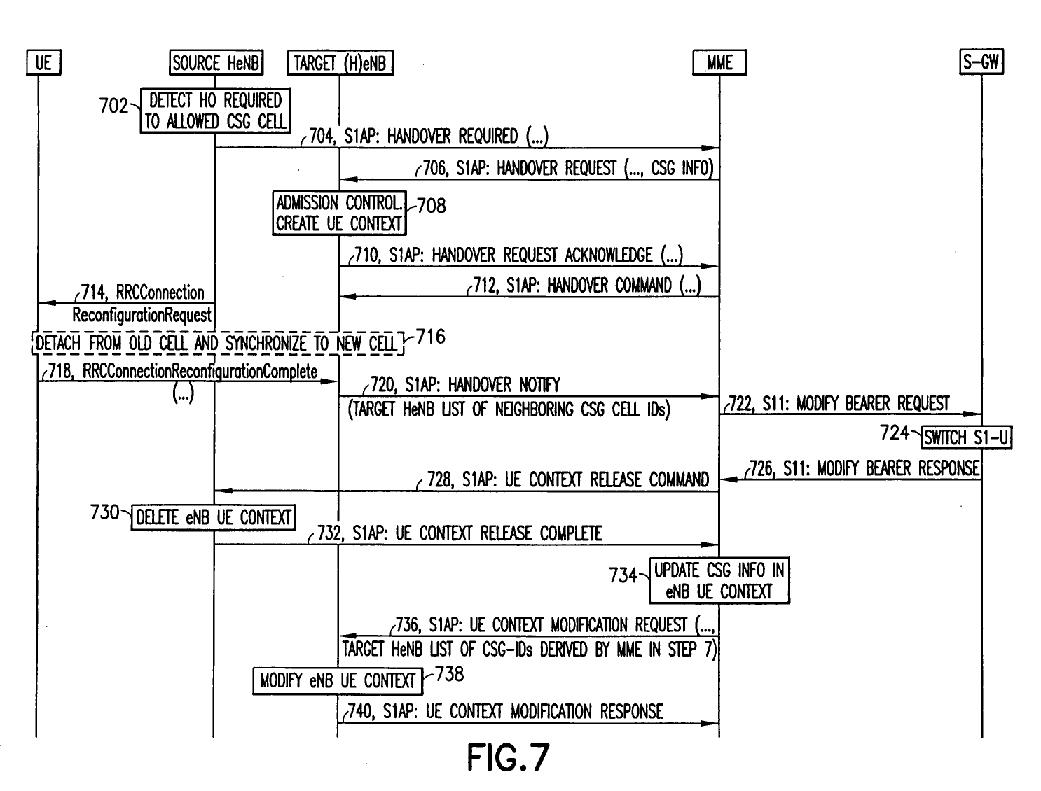

Once the terminal/UE is successfully handed-over to the target cell as a result of the mechanism shown in FIG. 5 and UE moves out of coverage of the source cell, then the second part of the general procedure can begin and this is shown by example at the signaling diagrams of FIGS. 6-7. The handover decided at FIG. 5 is completed at the upper portion of FIG. 6: at message 620 and 621 the source and target HeNB exchange HO request and HO Request Acknowledge (ACK) messages with one another over their mutual X2 interface, the source HeNB sends a RRC HO command to the UE who responds to the target HeNB with a RRC HO conform message as shown in messages 622 and 623 of FIG. 6.

Now the X2 based HO is executed. The target HeNB of that HO then at message 624 sends a Path Switch Request to the serving MME. According to an exemplary embodiment of these teachings this message 624 includes the target HeNB (now the new serving HeNB) neighboring cells CSG-ID list. On reception of this message the MME at block 626 shall again derive the list of the actual CSG-IDs permitted for this subscriber, following the same steps as described with respect to FIG. 4. Once available those shall be returned at message 628 to the current serving cell via the Patch Switch Acknowledge message, and stored in the serving HeNB for access control purposes as shown at block 628. Thus if the RRC CONNECTED terminal will measure and report another inter-CSG neighboring HeNB the new serving cell (named in FIG. 6 as the target HeNB) will already have the needed information stored to perform access control before a HO happens.

One particular advantage of the embodiments detailed above is that the process of access control and gathering the needed information concerning a particular subscriber/UE happens in parallel to current HO procedures. The implementations noted above are done is such a way that the HeNBs do not need to issue new messages to enquire about a subscriber CSG subscription during inter-CSG HO attempts. The access control can be performed in those involved E-UTRAN nodes following receiving up-to-date information from the MME. The information received and stored in the HeNBs will be deleted along with the UE context upon the UE moving to the RRC IDLE state or being handed over.

These implementations are secure and reliable because the HeNB has always the most recent information concerning a subscriber's CSG subscription. In case the subscription has changed between when a HeNB has received the subscriber CSG-ID information and when a new HO is attempted for the UE, the MME can always update the relevant serving cell.

Additionally, the extended functionality in the MME is moderate and so is seen to be readily implemented. Deriving the neighbor-specific CSG list for a particular UE from the neighboring CSG-ID list and the subscriber CSG subscription information guarantees that the receiving node can perform reliable access control and that the process is secure in terms of user data confidentiality because only a relevant part of the subscriber CSG subscription information is revealed beyond the core network/MME, and what is revealed is automatically deleted by the HeNB once the UE moves to the RRC IDLE mode.

In the LTE system there is also a S1-based handover procedure, which is supported where the second part of the general procedure can be applied as illustrated at FIG. 7 where the MME and the S-GW are not co-located. The conventional S1 based HO procedures are detailed at 3GPP TS 23.401, and provides that the MME shall send in the Handover Request message 706 up-to-date CSG Status about UE membership to the CSG-ID of the target Cell/(H)eNB. This will be used in the target (H)eNB to verify whether the UE is allowed to move to this cell. It should be noted that in the conventional procedure the MME cannot know the neighboring CSG-IDs for the target (H)eNB at this phase. When the handover is successfully executed then in the conventional HO procedure the target (H)eNB shall send a Handover Notify message (similar to message 720 of FIG. 7 but without the list of neighbor cell CSG-IDs) to the MME.

The first portion of the S1-based HO procedure is similar to the FIG. 6 implementation but with an S1 HO instead of an X2 HO: at block 702 the source HeNB detects the UE needs to be handed over to the target HeNB which is an allowed CSG cell for that UE and sends message 704 to the MME which is a S1 HO request message. The MME then sends message 706 to the target HeNB which is a S1 HO request message which triggers the target HeNB to perform admission control as in FIG. 6 and store the UE context as detailed above. The source HeNB then sends message 714 to the UE which is a RRC Reconfiguration Request message telling of the HO, and when the UE detaches from the source HeNB the source HeNB does not yet delete its stored context for that UE (in case the HO is not successful so as to avoid the UE having to re-establish via a random access RACH procedure)). The UE completes the HO to the target HeNB by sending it a RRC Reconfiguration Complete message 718.

The difference at FIG. 7 is in the second part of the procedures as noted above, preparing the target HeNB (now the new serving HeNB) for eventual HO of its newly acquired UE. The S1 HO notify message 720 is extended by FIG. 7 to include the target (now serving) HeNB neighboring cells CSG-ID list into this notification.

Upon reception of the Handover Notification message 720 the MME shall again derive the list of the actual CSG-ID permitted for this subscriber, following the same steps as described in FIG. 4. If the S-GW is not co-located in the same entity as the S-GW then the MME requests at 722 to modify the bearer request, the S-GW 724 switches the S1 interface relevant to this UE to the target HeNB (new serving HeNB) and re-assigns a new bearer if needed which it reports at message 726 in a modify bearer response message.

It is at this point the MME sends to the original source HeNB a S1 UE Context Release command at message 728. The source HeNB in response deletes at block 730 the stored context for that handed-over UE and replies to the MME with message 732 which is a UE Context Release Complete message.

Now at block 734 the MME updates the UE context with the list of neighbor CSG-IDs which were provided by the target (new serving) HeNB, and possibly also to reflect any changes to the UE's whole Allowed CSG list which are relevant to those neighbor CSG-IDs. The target (new serving) HeNB stores this UE context for the UE which was handed over by messages 706, 710, and 718 (from the target HeNB's perspective). Then the target (new serving) HeNB confirms the new UE context to the MME via message 740, a S1 UE Context Modification Response message.

In one implementation of the S1-based HO procedure the MME shall not send any response to the target (H)eNB after reception of the Handover Notify message 720. Having the MME send a UE Context Modification message 736, extended as above from the conventional one described at 3GPP TS 36.413, immediately after the S1 based HO procedure is completed in order to deliver the list of the actual CSG-IDs permitted for this subscriber/UE to the target (now serving) (H)eNB for access control purposes.

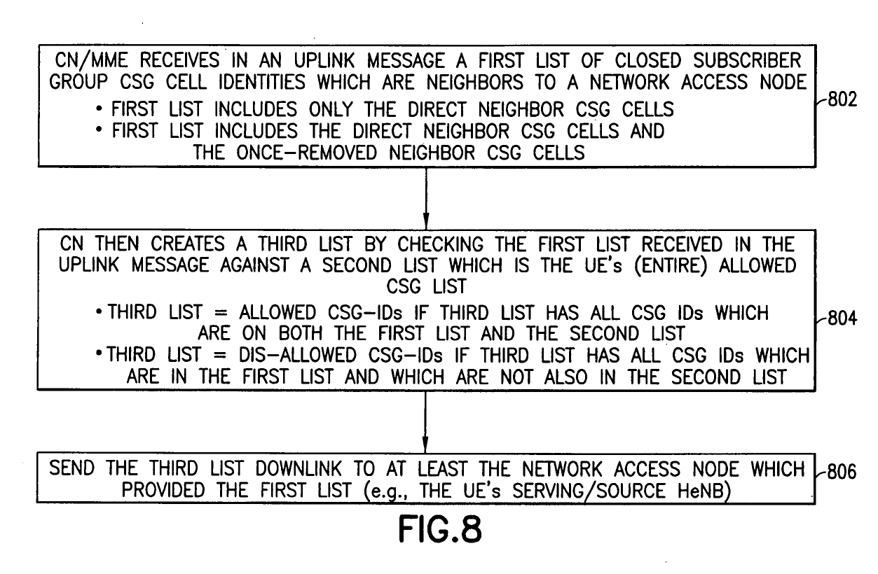

FIG. 8 is a logic flow diagram that illustrates the operation of a method, and a result of execution of computer program instructions, in accordance with the exemplary embodiments of this invention from the perspective of the core network. The elements of FIG. 8 may be performed by one node in the CN such as the mobility management entity as noted above or by a radio network controller for the case of a UTRAN radio access network, or they may be shared and performed by two or more CN nodes.

In accordance with these exemplary embodiments at block 802 the CN/MME receives in an uplink message a first list of closed subscriber group identities for cells which are neighbors to a network access node. In the examples above this first list included in one embodiment the direct neighbor CSG cells, and also the once-removed neighbor CSG cells (those which are adjacent to the direct neighbor CSG cells). This uplink message is received from the network access node directly, or possibly through a HeNB gateway if one is present and the network access node is a HeNB.

At block 804 the CN then creates a third list by checking the first list received in the uplink message against a second list which is the UE's (entire) allowed closed subscriber group list. This third list is detailed above as the one which is provided to then various HeNB's for access control of that particular UE. In effect this third list is the first list filtered by the second list. For the case the third list is the allowed CSG-IDs of the neighbor cells it consists of CSG identifiers for those closed subscriber group neighbor cells which are in the first list and also in the second list. For the case the third list is the dis-allowed CSG-IDs of the neighbor cells it consists of CSG identifiers for those closed subscriber group neighbor cells which are in the first list and which are not also in the second list.

At block 806 the CN then sends the third list downlink to at least the network access node which provided the first list, which in the examples above is the serving/source HeNB for the UE. The above examples give specific implementations of the uplink message of block 802 and the downlink message of block 806, but these implementations are exemplary and non-limiting to the broader embodiments of these teachings.

The various blocks shown in FIG. 8 may be viewed as method steps, and/or as operations that result from operation of computer program code, and/or as a plurality of coupled logic circuit elements constructed to carry out the associated function(s).

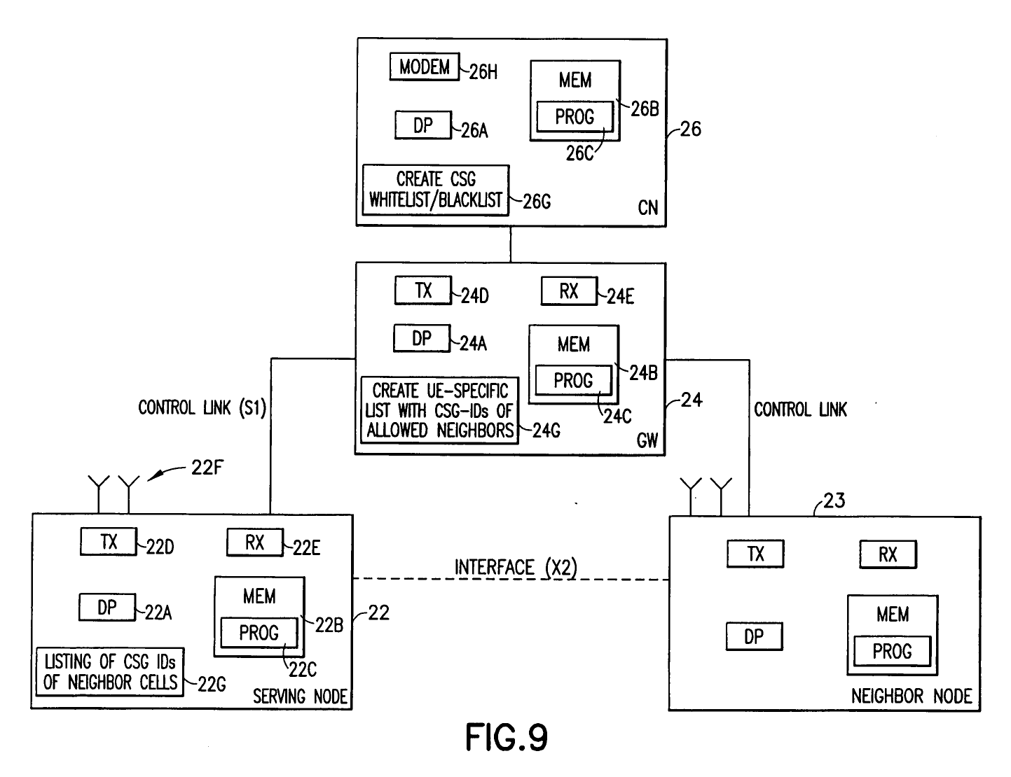

Reference is now made to FIG. 9 for illustrating a simplified block diagram of various electronic devices and apparatus that are suitable for use in practicing the exemplary embodiments of this invention. In FIG. 9 a serving cell 22 is adapted for communication over a wireless link with a mobile apparatus, such as a mobile terminal or UE (not shown). The serving cell 22 may be implemented as a HeNB as in the examples above, or as another type of access node which restricts access to non-subscribers. The serving cell 22 may have a direct interface to the CN 26 as is possible in the LTE system, or it may interface to the CN 26 through a serving GW 24 such as a HeNB GW.

The serving node 22 includes processing means such as at least one data processor (DP) 22A, storing means such as at least one computer-readable memory (MEM) 22B storing at least one computer program (PROG) 22C, and also communicating means such as a transmitter TX 22D and a receiver RX 22E for bidirectional wireless communications with the UE via one or more antennas 22F. Also shown for the serving node 22 at block 22G is the first list which include the CSG IDs of its neighbor cells (direct neighbor cells or also including the once-removed neighbors in different implementations). This was described above as the neighbor CSG list, and the serving cell has it stored in its memory for sending in the uplink message detailed in various figures above.

For completeness there is shown one of several neighbor nodes 23 which includes its own processing means such as at least one data processor (DP), storing means such as at least one computer-readable memory (MEM) storing at least one computer program (PROG), and communicating means such as a transmitter TX and a receiver RX for bidirectional wireless communications with other UEs under its control via one or more antennas. In certain implementations the neighbor second node 23 may be embodied as a HeNB. For the HeNB implementation there may be an X2 interface directly between the serving node 22 and the neighbor node 23 as noted above. In the examples above the neighbor node represents the target HeNB which after the first HO from the source HeNB then becomes the new serving HeNB to the same UE which was just handed over to it.

Similarly, if there is a serving gateway S-GW disposed functionally between the HeNB and the MME, such a S-GW may be implemented as a HeNB GW which includes processing means such as at least one data processor (DP) 24A, storing means such as at least one computer-readable memory (MEM) 24B storing at least one computer program (PROG) 24C, and communicating means such as a modem 24H for bidirectional communication with the serving node 22 via the control link and also with the neighbor node over the other control link. In an LTE embodiment these control links are implemented as S1 interfaces. While not particularly illustrated for the serving or neighbor nodes they also are assumed to include as part of their wireless communicating means a modem; for those devices it is assumed to be inbuilt with the TX and/or RX. The GW 24 has stored in its local memory at 24G the allowed or disallowed neighbor CSG-ID list of FIG. 8's block 806 as received from the MME. In the case of a HeNB gateway this S-GW may perform access control of the UE moving from the serving cell 22 without further assistance from the CN 26.

As noted above the CN 26 may be implemented as a MME in the LTE system. It also includes processing means such as at least one data processor (DP) 26A, storing means such as at least one computer-readable memory (MEM) 26B storing at least one computer program (PROG) 26C, and communicating means such as a modem 26H for bidirectional communication with the GW 24 as well as with other CNs, registry servers holding the various UE contexts and the UE-specific (full) Allowed CSG Lists and the like, as well as the Internet and publicly switched telephone networks. The CN 26 has stored in its local memory at 26G the listing of the CSG-IDs of the allowed (or disallowed) neighbor cells as noted above which is sent downlink to the GW 24, and also the CN 26 has stored in its memory the algorithm used to create that UE-specific list of the CSG-IDs of the allowed or disallowed neighbor CSG cells.

At least one of the PROGs 26C in the CN 26 is assumed to include program instructions that, when executed by the associated DP 26A, enable the device to operate in accordance with the exemplary embodiments of this invention, as detailed above. The serving node 22 and the GW 24 also have software stored in their respective MEMs to implement certain aspects of these teachings as detailed above. In these regards the exemplary embodiments of this invention may be implemented at least in part by computer software stored on the MEM 26B, 24B, 22B which is executable by the DP 26A of the CN 26 and/or by the DP 24A/22A of the respective GW 24 and serving node 22, or by hardware, or by a combination of tangibly stored software and hardware (and tangibly stored firmware). Electronic devices implementing these aspects of the invention need not be the entire devices as depicted at FIG. 4, but exemplary embodiments may be implemented by one or more components of same such as the above described tangibly stored software, hardware, firmware, DP, or various combinations thereof.

Various embodiments of the computer readable MEMs 22B, 24B and 28B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 22A, 24A and 28A include but are not limited to general purpose computers, special purpose computers, microprocessors, digital signal processors (DSPs) and multi-core processors.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

While the exemplary embodiments have been described above in the context of the EUTRAN/LTE system, it should be appreciated that the exemplary embodiments of this invention are not limited for use with only that particular radio access technology and these teachings may be used to advantage in other wireless communication systems which utilize networks and access nodes which provide restricted access, such as for example CSG cells in the UTRAN system.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof

We claim:

1. A method comprising:
receiving in an uplink message a first list of closed subscriber group identities for cells which are neighbors to a network access node;
creating a third list by checking the first list received in the uplink message against a second list which is a user equipment's list of allowed closed subscriber group identities; and
sending the third list downlink to at least the network access node which provided the first list.

2. The method according to claim 1, in which the neighbors of the first list includes only cells which are direct neighbor closed subscriber group cells.

3. The method according to claim 1, in which the neighbors of the first list include only cells which are direct neighbor closed subscriber group cells and cells which are adjacent to the direct neighbor closed subscriber group cells.

4. The method according to claim 1, in which the method is executed by a core network entity which receives the uplink message from the network access node either directly or through a home eNB gateway.

5. The method according to claim 4, in which the core network entity is a mobility management entity or a radio network controller, and the network access node is a serving node for the user equipment.

6. The method according to claim 1, the method further comprising:
providing the third list to home eNBs for access control of the user equipment.

7. The method according to claim 1, in which the third list consists of closed subscriber group identities for those closed subscriber group neighbor cells which are in the first list and also in the second list and thus includes all the allowed closed subscriber group identities of the cells which are neighbors to a network access node.

8. The method according to claim 1, in which the third list consists of closed subscriber group identities for those closed subscriber group neighbor cells which are in the first list and which are not also in the second list.

9. An apparatus comprising:
at least one processor; and
at least one memory storing computer program code;
In which the at least one memory with the computer program code is configured with the at least one processor to cause the apparatus to perform actions comprising:
receiving in an uplink message a first list of closed subscriber group identities for cells which are neighbors to a network access node;
creating a third list by checking the first list received in the uplink message against a second list which is a user equipment's list of allowed closed subscriber group identities; and
sending the third list downlink to at least the network access node which provided the first list.

10. The apparatus according to claim 9, in which the neighbors of the first list includes only cells which are direct neighbor closed subscriber group cells.

11. The apparatus according to claim 9, in which the neighbors of the first list include only cells which are direct neighbor closed subscriber group cells and cells which are adjacent to the direct neighbor closed subscriber group cells.

12. The apparatus according to claim 9, in which the apparatus comprises a core network entity which receives the uplink message from the network access node either directly or through a home eNB gateway.

13. The apparatus according to claim 12, in which the core network entity is a mobility management entity or a radio network controller, and the network access node is a serving node for the user equipment.

14. The apparatus according to claim 9, the actions further comprising:
providing the third list to home eNBs for access control of the user equipment.

15. The apparatus according to claim 9, in which the third list consists of closed subscriber group identities for those closed subscriber group neighbor cells which are in the first list and also in the second list and thus includes all the allowed closed subscriber group identities of the cells which are neighbors to a network access node.

16. The apparatus according to claim 9, in which the third list consists of closed subscriber group identities for those closed subscriber group neighbor cells which are in the first list and which are not also in the second list.

17. A memory storing computer program code, which when executed by at least one processor result in actions comprising:
receiving in an uplink message a first list of closed subscriber group identities for cells which are neighbors to a network access node;
creating a third list by checking the first list received in the uplink message against a second list which is a user equipment's list of allowed closed subscriber group identities; and
sending the third list downlink to at least the network access node which provided the first list.

18. The memory according to claim 17, in which the neighbors of the first list includes only cells which are direct neighbor closed subscriber group cells.

19. The memory according to claim 17, in which the neighbors of the first list include only cells which are direct neighbor closed subscriber group cells and cells which are directly adjacent to the direct neighbor closed subscriber group cells.

20. The memory according to claim 17, in which the third list consists of either:
closed subscriber group identities for those closed subscriber group neighbor cells which are in the first list and also in the second list and thus includes all the allowed closed subscriber group identities of the cells which are neighbors to a network access node; or
closed subscriber group identities for those closed subscriber group neighbor cells which are in the first list and which are not also in the second list.
